(19) United States
(12) Patent Application Publication
(10) Pub. No.: US 2012/0128410 A1
(43) Pub. Date: May 24, 2012

(54) CLIP

(75) Inventor: Hajime Naoi, Yokohama-shi (JP)

(73) Assignee: NIFCO INC., Yokohama-shi, Kanagawa, (JP)

(21) Appl. No.: 13/382,723

(22) PCT Filed: Jul. 14, 2010
(86) PCT No.: PCT/JP2010/061924

§ 371 Date: Feb. 6, 2012

(30) Foreign Application Priority Data
Jul. 17, 2009 (JP) 2009-168493

(51) Int. Cl. F16B 2/22

(52) U.S. Cl. 403/291

(57) ABSTRACT

A clip includes an attaching portion and a clamp portion. An elastic member, which is formed as a separate body from the attaching portion, is attached to the attaching portion, and prevents a transmission of vibration between an attached member and a tubular object. In the elastic member, a vibration-proof portion is provided and elastically abuts against a locking piece.

### FIELD OF TECHNOLOGY

The present invention relates to a clip for attaching a tubular object such as, for example, a fuel pipe, a brake pipe, and the like for an automobile, to an attached member such as a body and the like. Especially, an elastic member is formed as a separate body from an attaching portion, and the elastic member is attached to the attaching portion so as to prevent transmission of vibration between the attached member and the tubular object.

### BACKGROUND ART

Conventionally, there is well known a clamp in which a vibration-proof member made of soft synthetic resin is integrally provided on an outer circumference of the attaching portion made of hard synthetic resin by a molding (for example, see paragraph [0008], and FIGS. 1, and 7 to 10 in Patent Document 1).

### PRIOR ART DOCUMENT

### Patent Document

Patent Document 1: Japanese Unexamined Patent Publication No. 2003-214559

### SUMMARY OF THE INVENTION

### Problems to be Solved by the Invention

However, in the conventional clamp, the vibration-proof member made of the soft synthetic resin is integrally provided on the outer circumference of the attaching portion made of the hard synthetic resin by the molding, so that there has been a problem that a structure of the attaching portion becomes complicated, or that the molding is also difficult.

Thereby, the present invention is made in view of the aforementioned problems that a conventional technology has, and an object of the present invention is to provide a clip so as to prevent the transmission of the vibration between the attached member and the tubular object.

### Means for Solving the Problems

A clip according to the first aspect of the present invention has the following characteristics.

First, the clip comprises the following structure.

(1) Attaching Portion

An attaching portion includes a locking piece locked in a stud bolt provided in an attached member.

(2) Clamp Portion

A clamp portion is connected to the attaching portion, and includes a holding portion holding a tubular object.

Secondly, in the attaching portion, there is attached an elastic member which is formed as a separate body from the attaching portion, and prevents transmission of vibration between the attached member and the tubular object.

Thirdly, in the elastic member, there is provided a vibration-proof portion elastically abutting against the locking piece.

The clip according to the first aspect of the present invention may have the following characteristic.

In the elastic member, there is provided an abutting portion elastically abutting against the attached member.

Thereby, the abutting portion of the elastic member is elastically abutted against the attached member so as to prevent the transmission of the vibration from an abutting surface between the attached member and the attaching portion.

The clip according to the first aspect of the present invention may have the following characteristic.

Inside the vibration-proof portion, there is formed a hollow portion.

Thereby, the hollow portion is formed inside the vibration-proof portion so as to be capable of improving an elastic property of the vibration-proof portion.

The clip according to a second aspect of the present invention has the following characteristics.

First, the clip comprises the following structure.

(1) Attaching Portion

The attaching portion includes the locking piece locked in the stud bolt provided in the attached member.

(2) Clamp Portion

The clamp portion is connected to the attaching portion, and includes the holding portion holding the tubular object.

Secondly, the attaching portion comprises the following structure.

(3) Insert Hole

An insert hole is for inserting the stud bolt.

(4) A Pair of Side Walls

A pair of side walls faces each other by sandwiching the insert hole.

(5) A Pair of Locking Pieces

A pair of locking pieces is connected to the side walls through a thin-walled hinge portion, and protrudes to an inside of the insert hole so as to be locked in the stud bolt.

Thirdly, the hinge portion is molded by soft synthetic resin.

Fourthly, the rest of the attaching portion is molded by relatively hard synthetic resin.

The clip according to the second aspect of the present invention may comprise the following characteristics.

First, in the attaching portion, there is provided the abutting portion (for example, an upper wall and an elastic piece) elastically abutting against the attached member.

Secondly, the abutting portion (for example, the upper wall and the elastic piece) is molded by the soft synthetic resin.

Thereby, the abutting portion of the elastic member is elastically abutted against the attached member so as to prevent the transmission of the vibration from the abutting surface between the attached member and the attaching portion.

### Effect of the Invention

Since the present invention is structured as mentioned above, the following effects can be obtained.

According to the clip of the first aspect of the present invention, the elastic member is formed as the separate body from the attaching portion, and the elastic member is attached to the attaching portion so as to prevent the transmission of the vibration between the attached member and the tubular object. Also, the structure of the attaching portion is allowed to be simplified, and by attaching the elastic member to the attaching portion, the clip can be easily manufactured.

According to the clip of the second aspect of the present invention, the hinge portion of the locking piece is molded by the soft resin so as to prevent the transmission of the vibration between the attached member and the tubular object as is the case with the clip according to the first aspect of the present invention. Also, when the stud bolt is inserted into the insert hole, the locking piece made of the soft resin elastically abuts against the side walls made of the hard resin so as to be capable of attenuating the vibration between the attached member and the tubular object.

### BRIEF DESCRIPTION OF THE DRAWINGS

FIG. 1 is a partial cross sectional view of a clip according to the first embodiment of the present invention.

FIG. 2 is a side view of the clip in an attached state.

FIG. 3 is a partially exploded perspective view of the clip.

FIG. 4 is a side view of a clip main body.

FIG. 5 is a partial side view of the clip main body.

FIG. 6 is a plan view corresponding to FIG. 5.

FIG. 7 is a bottom plan view corresponding to FIG. 5.

FIG. 8 is another side view corresponding to FIG. 5.

FIG. 9 is a cross sectional view taken along a line A-A in FIG. 6.

FIG. 10 is a side view of an elastic member according to the first embodiment of the present invention.

FIG. 11 is a plan view of the elastic member.

FIG. 12 is a bottom plan view of the elastic member.

FIG. 13 is another side view of the elastic member.

FIG. 14 is a cross sectional view taken along a line B-B in FIG. 11.

FIG. 15 corresponds to FIG. 3, and is a partial perspective view of the clip in an assembly state.

FIG. 16 corresponds to FIG. 15, and is a partial side view of the clip.

FIG. 17 is a side view of the clip in the assembly state.

FIG. 18 is a partial side view of the clip for explaining the attached state.

FIG. 19 is a partial side view of the clip in the attached state.

FIG. 20 shows a second embodiment of the present invention, and is a perspective view of the elastic member.

FIG. 21 shows a third embodiment of the present invention, and is a partial cross sectional view of the clip.

FIG. 22 shows a fourth embodiment of the present invention, and is a partially cross sectional view of the clip.

### EMBODIMENTS FOR CARRYING OUT THE INVENTION

(Clip 10)

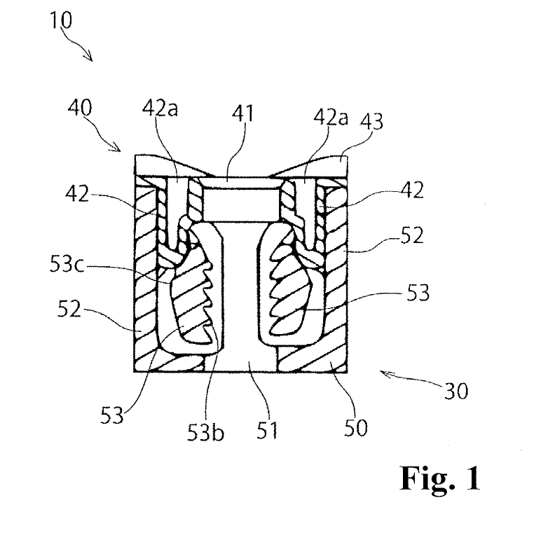

In FIGS. 1 to 3, the reference numeral 10 represents a clip for attaching tubular objects P1 to P4 such as a fuel pipe, a brake pipe, and the like for an automobile, to an attached member 20 such as a body and the like.

Although it is not shown in the figures, the attached member 20 is disposed inside a bonnet, and a stud bolt 21 is provided to stand on a surface thereof.

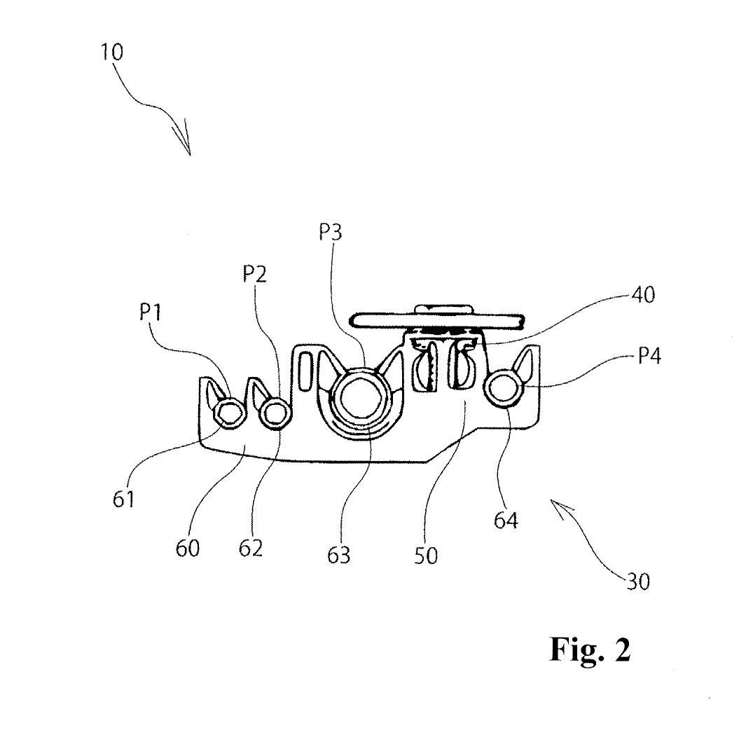

The stud bolt 21 extends downward from a lower surface of the attached member 20 in FIG. 2, and although it is not shown in the figures, on an outer circumference of an axis portion thereof, a screw groove is engraved.

A plurality of tubular objects P1 to P4, for example, four pieces, is attached to the clip 10. As for the tubular objects P1 to P4, a first tubular object P1, a second tubular object P2, a third tubular object P3, and a fourth tubular object P4 are attached from the left side in FIG. 2. The first tubular object P1 and the second tubular object P2 are, for example, a brake pipe. Also, the third tubular object P3 and the fourth tubular object P4 are a fuel pipe.

Incidentally, although the brake pipe and the fuel pipe are illustrated as an example of the tubular objects P1 to P4, the tubular objects P1 to P4 are not limited to the pipes, and may be an electric cable type. Also, although the automobile is illustrated as an example of the attached member 20, the attached member 20 is not limited to the above, and may be other vehicles such as trains, aircraft, boats and ships, and the like, or may be other machine equipment or electric equipment. Also, the attached member 20 may be a building, a construction product, and the like. Moreover, although the tubular objects P1 to P4 are attached to the clip 10 with the four pieces, the number of the tubular objects P1 to P4 is not limited to the above, and the tubular objects P1 to P4 may be attached with one to three pieces, or five or more pieces.

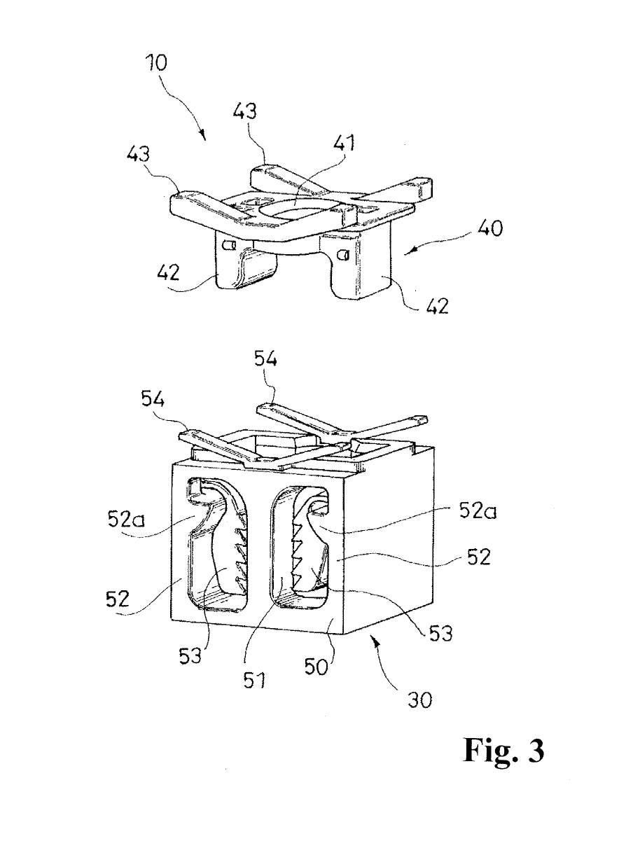

As shown in FIG. 3, the clip 10 comprises roughly the following parts.

Incidentally, the following (1) and (2) will be described hereinafter.

(1) Clip main body 30

(2) Elastic member 40

Incidentally, the parts of the clip 10 are not limited to the aforementioned (1) and (2).

(Clip Main Body 30)

The clip main body 30 comprises an attaching device to the stud bolt 21, and a holding device for the tubular objects P1 to P4. The clip main body 30 has, for example, an appropriate amount of elasticity and rigidity, and is integrally molded by hard resin compared to the later-mentioned elastic member 40, for example, the hard resin such as polypropylene and the like.

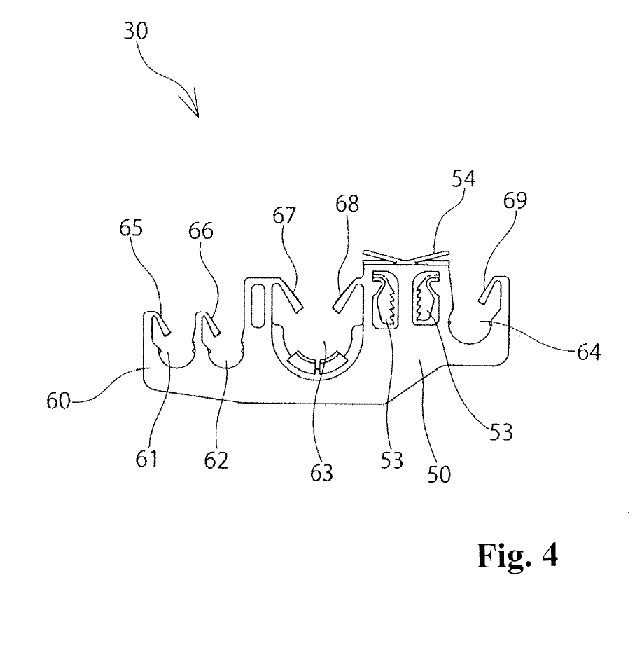

Specifically, as shown in FIG. 4, the clip main body 30 roughly comprises the following respective portions.

Incidentally, the following (1) and (2) will be described hereinafter.

(1) Attaching portion 50

(2) Clamp portion 60

Incidentally, each portion of the clip main body 30 is not limited to the aforementioned (1) and (2).

(Attaching Portion 50)

As shown in FIGS. 1 to 3, the attaching portion 50 includes locking pieces 53 locked in the stud bolt 21 provided in the attached member 20.

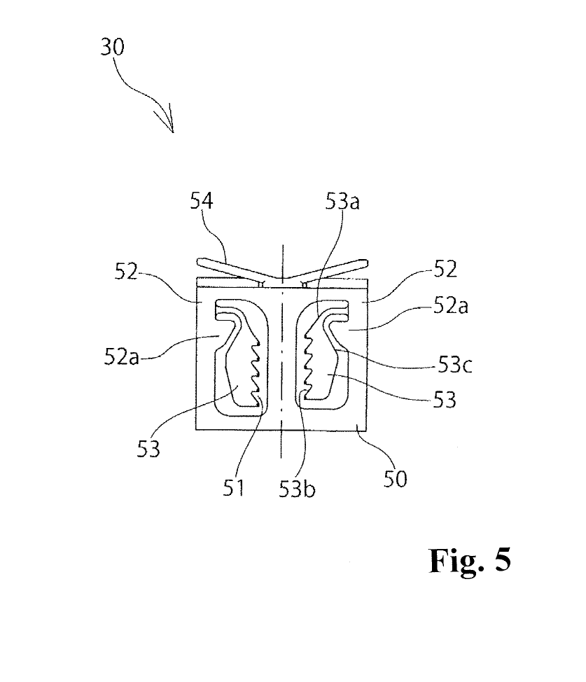

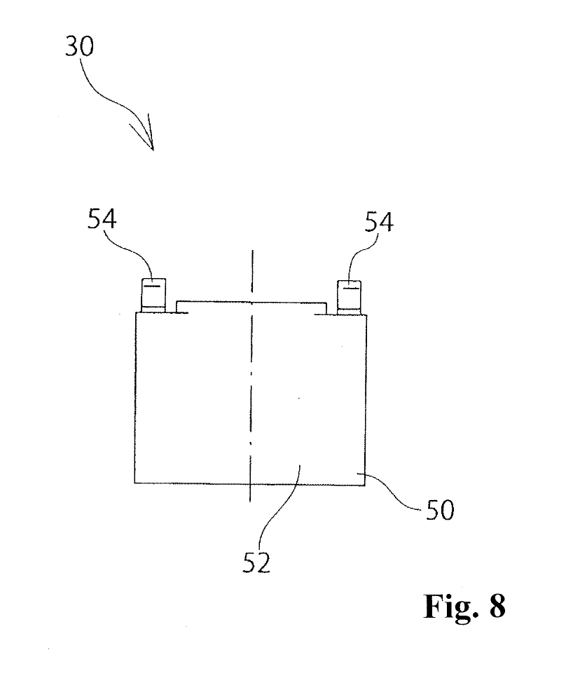

Specifically, as shown in FIGS. 5 to 9, the attaching portion 50 is formed in a box shape, and comprises the following respective portions including the aforementioned locking pieces 53.

Incidentally, the following (1) to (5) will be described hereinafter.

(1) Insert hole 51

(2) Side walls 52

(3) Locking pieces 53

(4) Elastic pieces 54

(5) Insertion holes 55

Incidentally, each portion of the attaching portion 50 is not limited to the aforementioned (1) to (5).

(Insert Hole 51)

As shown in FIGS. 5 to 7, the insert hole 51 is for inserting the stud bolt 21. Specifically, the insert hole 51 passes through the upper and lower surfaces of the attaching portion 50, and is formed in an oval shape.

Incidentally, although the oval shape is illustrated as an example of a shape of the attaching portion 50, the shape of the attaching portion 50 is not limited to the above, and may be formed in a shape of an ellipse, a circle, or a square.

(Side Walls 52)

As shown in FIGS. 5 to 9, the side walls 52 face each other by sandwiching an insert hole 131, and are formed as a pair.

Specifically, the side walls 52 face each other to right and left in FIG. 5.

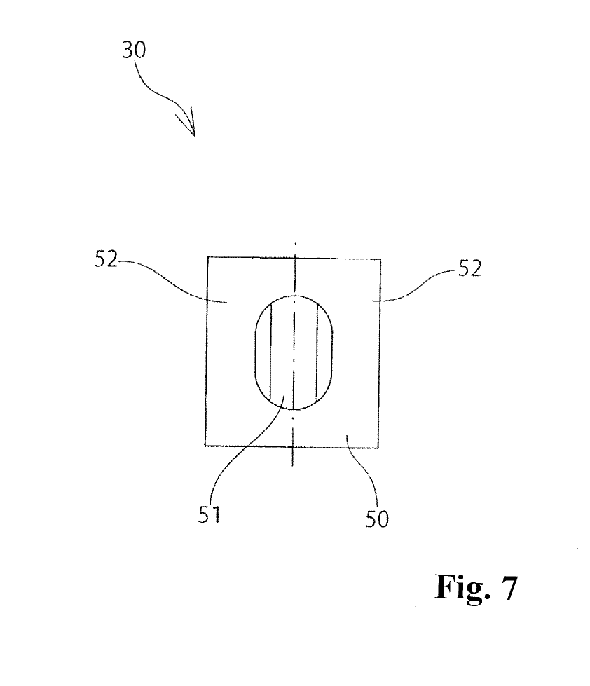

Incidentally, although the side walls 52 are formed as a pair facing each other to the right and left in FIG. 5, the side walls 52 are not limited to the above, and may be formed as a pair facing each other in an up-and-down direction in FIG. 7, or may be formed with a total of four pieces in four directions.

Specifically, as shown in FIG. 5, the side walls 52 comprise the following portion.

Incidentally, the portion of the side walls 52 is not limited to the following (1).

(1) Projecting Portions 52a

As shown in FIGS. 5 to 9, projecting portions 52a project toward an inside of the insert hole 131 in a triangle shape from upper portions of inner side surfaces of the side walls 52. The projecting portions 52a face each other by being separated from an outer side surface of a pair of the later-mentioned locking pieces 53. When the stud bolt 21 is inserted into an interval of a pair of the locking pieces 53, both the locking pieces 53 mutually open outward, and at that time, the outer side surfaces of the locking pieces 53 approach toward the projecting portions 52a.

(Locking Pieces 53)

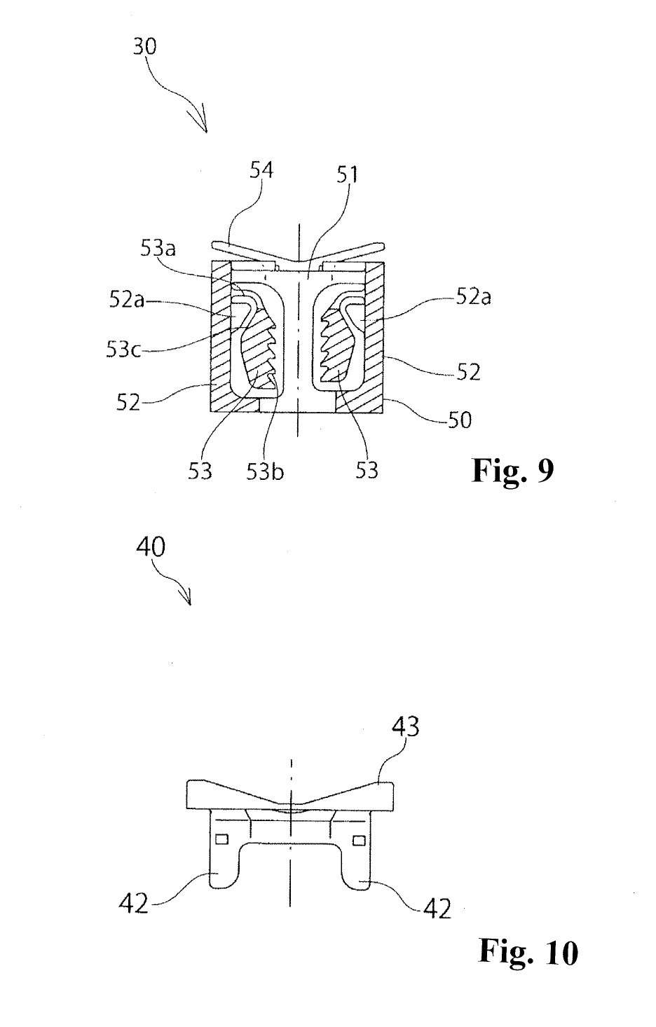

As shown in FIGS. 5 and 9, the locking pieces 53 connect to each side wall 52 through thin-walled hinge portions 53a, and protrude to an inside of the insert hole 51 so as to be locked in the stud bolt 21. The locking pieces 53 are formed with the same number as the side walls 52, i.e., a pair. The locking pieces 53 connect to the upper portions of the inner side surfaces of the side walls 52 through the hinge portions 53a, extend downward inside the insert hole 51, and are mutually positioned separately by maintaining a distance less than an outer diameter of the stud bolt 21.

Specifically, as shown in FIG. 5, the locking pieces 53 comprise the following respective portions including the aforementioned hinge portions 53a.

Incidentally, each portion of the locking pieces 53 is not limited to the following (1) to (3).

(1) Hinge Portions 53a

The hinge portions 53a are formed in each upper end portion of the locking pieces 53 in a thin-walled fashion, and connect to the upper portions of the inner side surfaces of the side walls 52.

(2) Claw Portions 53b

Claw portions 53b are respectively formed on the facing inner side surfaces of the locking pieces 53 in a saw-toothed shape with a plurality of steps, and mesh with a screw groove of the stud bolt 21.

(3) Inclined Portions 53c

Inclined portions 53c are respectively formed on the outer side surfaces of the locking pieces 53 which face the inner side surfaces of the side walls 52, and incline downward. The inclined portions 53c are separated from downward-inclined surfaces of the projecting portions 52a of the side walls 52 protruding in the triangle shape, and incline parallel to the inclined surfaces. As for the inclined portions 53c, when the stud bolt 21 is inserted into the interval of a pair of the locking pieces 53, both the locking pieces 53 mutually open outward, and at that time, the inclined portions 53c approach toward the downward-inclined surfaces of the projecting portions 52a.

(Elastic Pieces 54)

The elastic pieces 54 elastically abut against the attached member 20. Specifically, as shown in FIG. 3, the elastic pieces 54 are formed as a pair on the front and back by sandwiching the insert hole 51, and formed in an approximately V shape. The elastic pieces 54 are made for allowing an over-stroke, and elastically abut against the attached member 20 through the later-mentioned elastic member 40.

Incidentally, although a pair of the elastic pieces 54 is formed, the elastic pieces 54 are not limited to the above, and may be provided with one piece or three or more pieces.

(Insertion Holes 55)

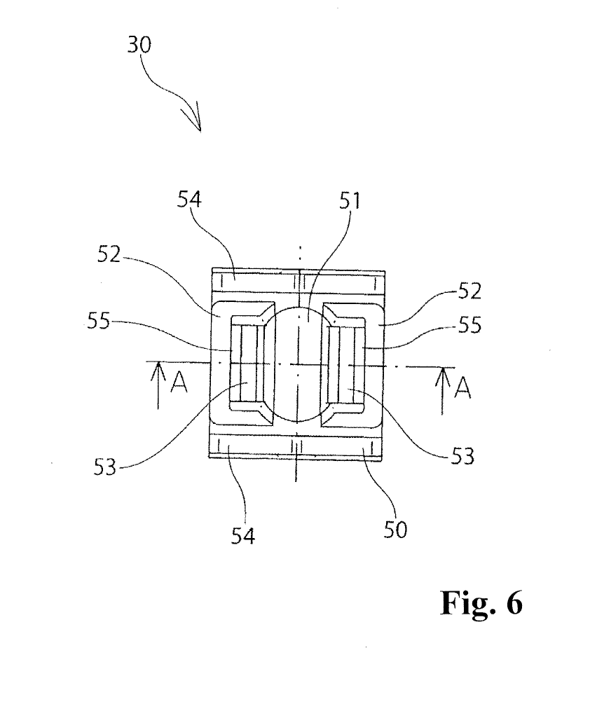

The insertion holes 55 are for inserting vibration-proof portions 42 of the later-mentioned elastic member 40, and are formed as a pair on both sides of the right and left of the insert hole 51 in FIG. 6.

Incidentally, although a pair of the insertion holes 55 is formed, the insertion holes 55 are not limited to the above, and may be provided with one piece or three or more pieces.

(Clamp Portion 60)

As shown in FIGS. 1 to 3, the clamp portion 60 connects to the attaching portion 50, and includes holding portions 61 to 64 holding the tubular objects P1 to P4.

Specifically, as shown in FIG. 4, the clamp portion 60 comprises the following respective portions including the aforementioned holding portions 61 to 64.

Incidentally, each portion of the clamp portion 60 is not limited to the followings (1) and (2).

(1) First to Fourth Holding Portions 61 to 64

As shown in FIG. 4, the first to fourth holding portions 61 to 64 are provided with a plural number, for example, four pieces, and are formed in a “U” shape whose upper surface is open, or in a “C” shape. Four pieces of the first to fourth holding portions 61 to 64 are the first holding portion 61, the second holding portion 62, the third holding portion 63, and the fourth holding portion 64 from the left side in FIG. 2.

Among the four pieces of the first to fourth holding portions 61 to 64, the third holding portion 63, which is on the left of the attaching portion 50 in FIG. 4, is set to have a large inner diameter compared to the other first holding portion 61, second holding portion 62, and fourth holding portion 64.

Incidentally, although the first to fourth holding portions 61 to 64 are provided with the four pieces, the holding portions 61 to 64 are not limited to the above, and may be provided with one to three pieces, or five or more pieces. Also, although the first to fourth holding portions 61 to 64 are formed in the “U” shape or the “C” shape, the holding portions 61 to 64 may be formed in a short form.

(2) First to Fourth Elastic Claws 65 to 69

The first to fourth elastic claws 65 to 69 are made for holding the first to fourth tubular objects P1 to P4, which are respectively held in the first to fourth holding portions 61 to 64, so that the first to fourth tubular objects P1 to P4 do not come out. The first to fourth elastic claws 65 to 69 are formed in an approximately “V” shape which is downwardly folded toward an inside of the respective first to fourth holding portions 61 to 64. Among the first to fourth elastic claws 65 to 69, the third elastic claw 67, which faces the third holding portion 63 having the large inner diameter, is formed with two pieces. The rest of the first elastic claw 65, the second elastic claw 66, and the fourth elastic claw 69, which face the first holding portion 61, the second holding portion 62, and the fourth holding portion 64, are respectively provided with one piece.

Incidentally, although the first to fourth elastic claws 65 to 69 are formed in a folding-back manner, the elastic claws 65 to 69 may have a structure of a projection shape. Also, although the first to fourth elastic claws 65 to 69 are formed with one to two pieces relative to the respective first to fourth holding portions 61 to 64, the elastic claws 65 to 69 are not limited to the above.

(Elastic Member 40)

As shown in FIGS. 1 to 3, the elastic member 40 is formed as the separate body from the attaching portion 50, and is attached to the attaching portion 50 so as to prevent the transmission of the vibration between the attached member 20 and the tubular objects P1 to P4. The elastic member 40 is integrally molded by soft resin compared to the clip main body 30, for example, the soft resin such as thermoplastic elastomer and the like.

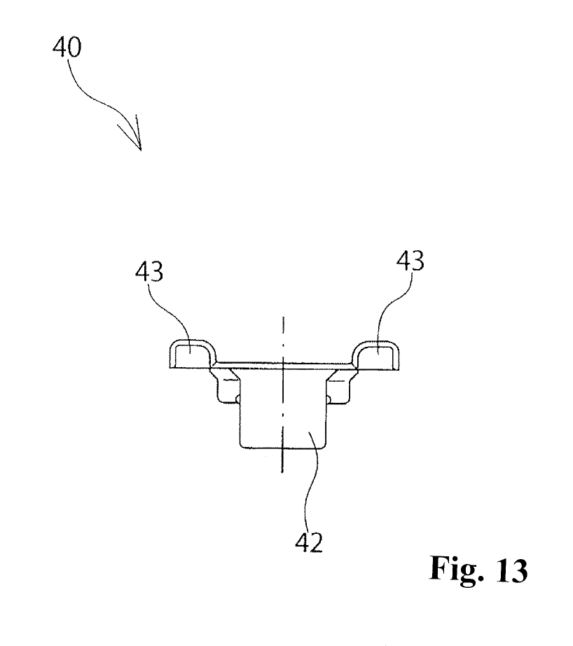

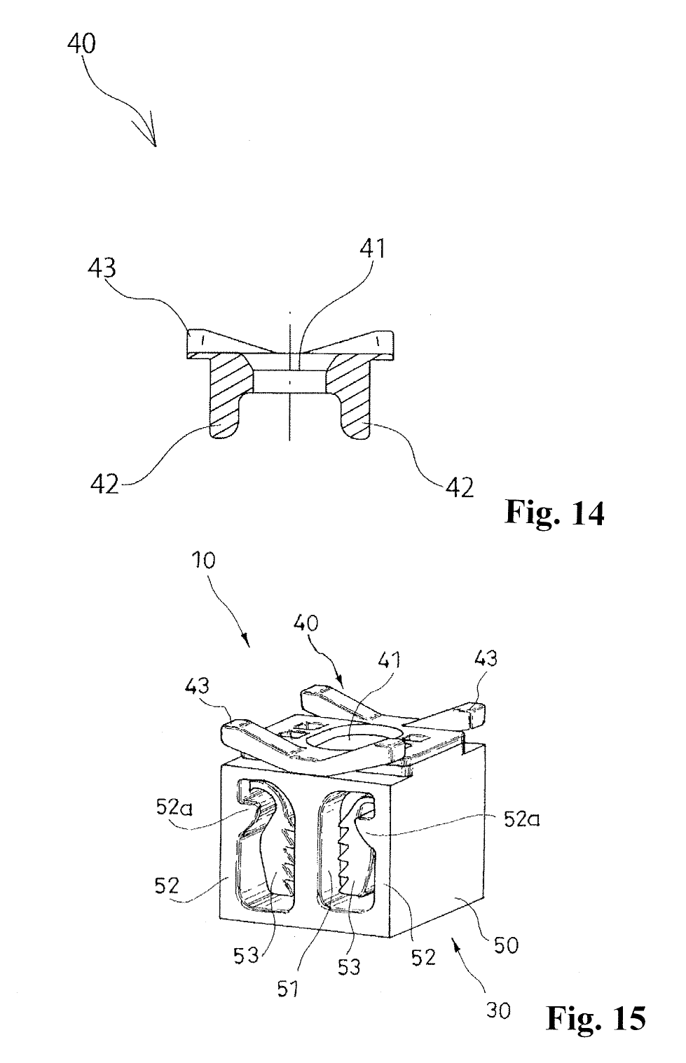

Specifically, as shown in FIGS. 10 to 14, the elastic member 40 comprises the following respective portions.

Incidentally, each portion of the elastic member 40 is not limited to the following (1) to (3).

(1) Communication Hole 41

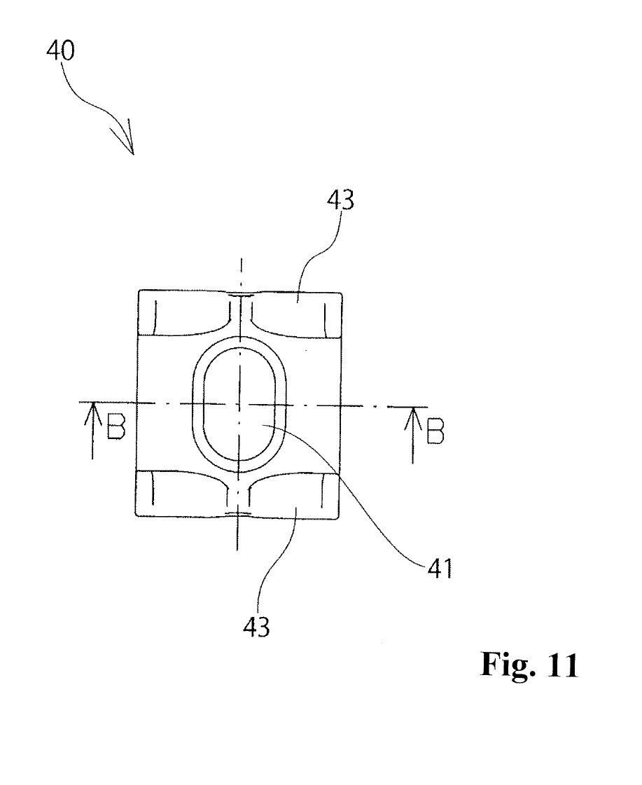

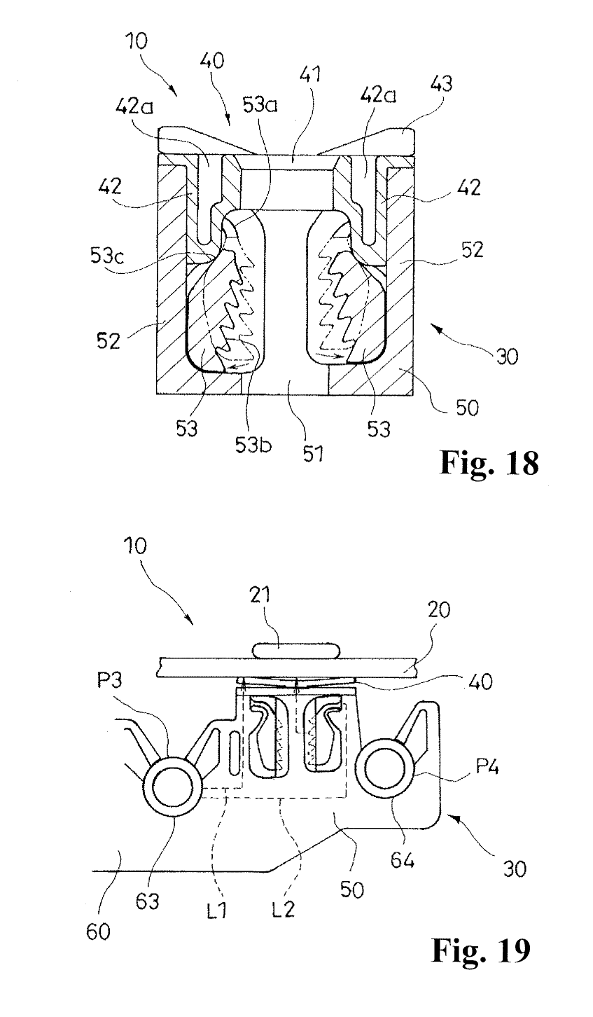

As shown in FIG. 18, a communication hole 41 communicates into the insert hole 51 of the attaching portion 50 of the clip main body 30. Specifically, as shown in FIGS. 11, 12, and 13, the elastic member 40 passes through up and down, and is formed in the oval shape in the same manner as the insert hole 51.

Incidentally, although the oval shape is illustrated as an example of the shape of the communication hole 41, the shape of the communication hole 41 is not limited to the above, and may be formed in the shape of the ellipse or the circle, or the square.

(2) Vibration-Proof Portions 42

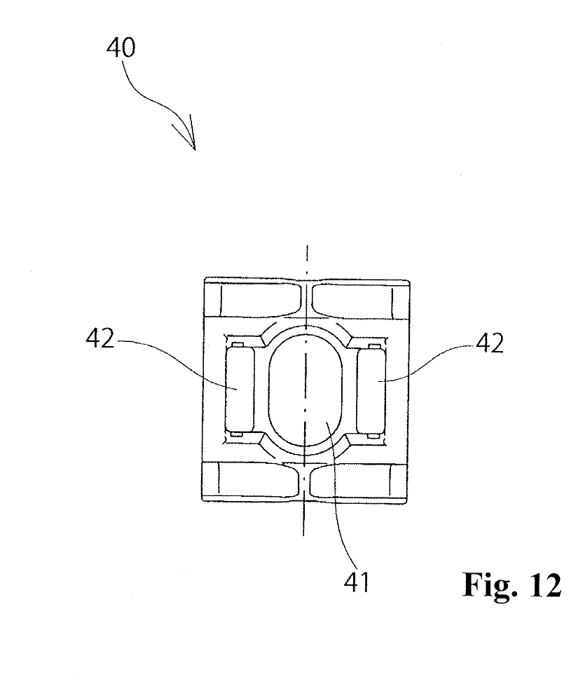

As shown in FIGS. 1 to 3, the vibration-proof portions 42 elastically abut against the locking pieces 53. Specifically, the vibration-proof portions 42 are formed as a pair on both sides of the right and left of the communication hole 41 in FIG. 12, and extend downward in a plate shape. The vibration-proof portions 42 are inserted into the insert hole 51 through the insertion holes 55 of the attaching portion 50 so as to be pushed into an interval between the locking pieces 53 and the projecting portions 52a of the side walls 52.

Also, as shown in FIG. 1, inside the vibration-proof portions 42, there are formed hollow portions 42a. The hollow portions 42a are formed in a pouch shape opening upward.

Incidentally, although the vibration-proof portions 42 are formed as a pair, the number of the vibration-proof portions 42 is not limited to the above, and may be formed with one piece, or three or more pieces.

(3) Abutting Portions 43

As shown in FIGS. 1 to 3, abutting portions 43 elastically abut against the attached member 20. Specifically, the abutting portions 43 are positioned in up-and-down directions of the communication hole 41 in FIG. 11. A thickness of the abutting portions 43 gradually increases toward right-and-left both side directions from the center in FIG. 10, and an upper surface of the abutting portions 43 is concaved in the approximately V shape.

The abutting portions 43 overlap on upper surfaces of the elastic pieces 54 of the attaching portion 50, and elastically abut against the attached member 20.

(Assembly Method)

Next, an assembly method of the clip main body 30 and the elastic member 40 comprising the aforementioned structure will be explained.

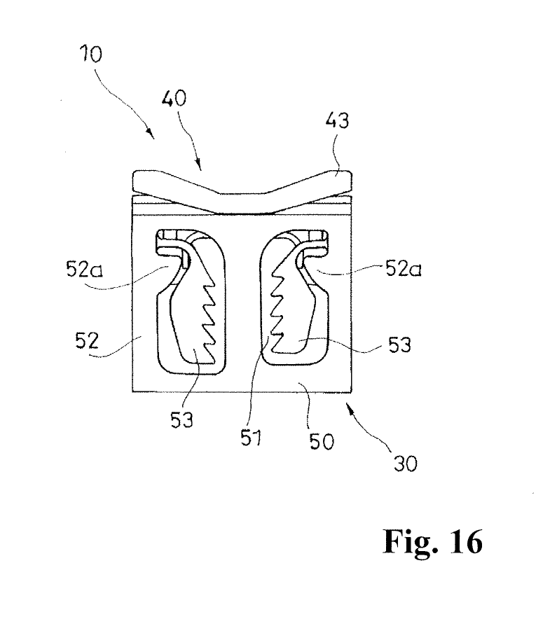

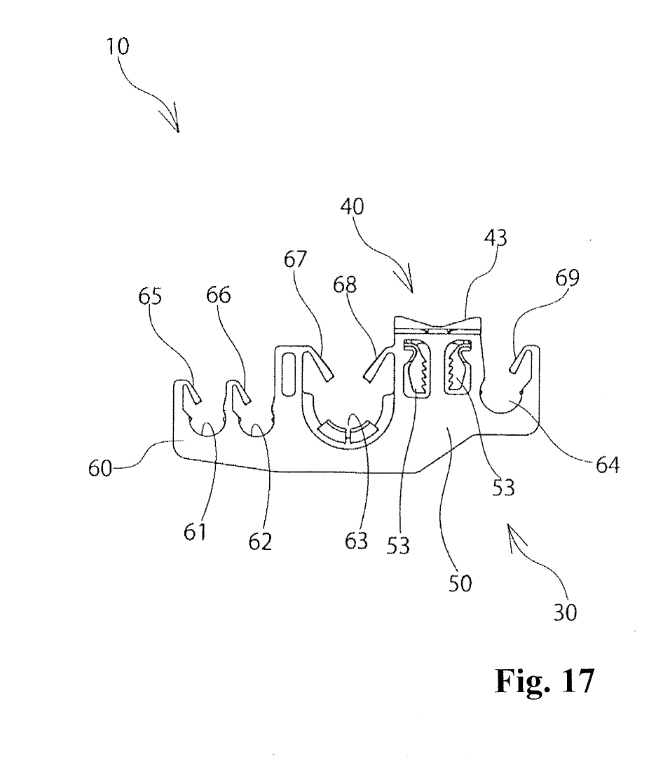

As shown in FIGS. 1, and 15 to 17, a pair of the vibration-proof portions 42 of the elastic member 40 is inserted while conforming to each insertion hole 55 of the attaching portion 50. When the vibration-proof portions 42 are inserted, the vibration-proof portions 42 protrude to the inside of the insert hole 51 through the insertion holes 55 so as to be pushed into the interval between the locking pieces 53 and the projecting portions 52a of the side walls 52.

At that time, the communication hole 41 communicates into the insert hole 51. Also, the abutting portions 43 overlap on the upper surfaces of the elastic pieces 54 of the attaching portion 50.

(Usage Method)

Next, a usage method of the clip 10 in an assembled state will be explained.

The tubular objects P1 to P4 may be placed in the first to fourth holding portions 61 to 64 of the clamp portion 60 of the clip 10 beforehand, or the tubular objects P1 to P4 may be placed after the clip 10 is attached to the attached member 20.

In order to attach the clip 10 to the attached member 20, the stud bolt 21 may be relatively inserted while conforming to the communication hole 41 of the elastic member 40. When the stud bolt 21 is inserted, an end portion thereof proceeds to the insert hole 51 of the attaching portion 50 from the communication hole 41 so as to be pushed into the interval of a pair of the locking pieces 53.

Here, when the stud bolt 21 is relatively strongly inserted, a pair of the locking pieces 53 is pushed by an outer circumference of the stud bolt 21, and as shown in FIG. 18, the locking pieces 53 bend at the center of the hinge portions 53a, so that the opposing interval of both the locking pieces 53 expand. Consequently, the stud bolt 21 proceeds inside the opposing interval of both the locking pieces 53.

After that, at a position wherein the abutting portions 43 of the elastic member 40 elastically abut against the attached member 20, an insertion of the stud bolt 21 reaches a limit, and the claw portions 53b of both the locking pieces 53 mesh with the screw groove of the stud bolt 21 so that the stud bolt 21 cannot come out of the insert hole 51. Accordingly, as shown in FIGS. 2 and 19, the clip 10 is fixed to the attached member 20 through the stud bolt 21.

(Vibration-Transmission Prevention Function)

Next, a vibration-transmission prevention function by the clip 10 fixed to the attached member 20 will be explained.

As shown in FIG. 19, as for a vibration-transmission route, the following two routes are conceivable.

(1) First Route L1

Citing an example of the third tubular object P3, there is the first route L1 which passes through the clamp portion 60, the attaching portion 50 (the elastic pieces 54), the abutting portions 43 of the elastic member 40, and the attached member 20. In the first route L1, the transmission of the vibration can be prevented due to the elasticity of the abutting portions 43 of the elastic member 40.

Incidentally, as the vibration between the attached member 20 and the tubular object P3, for example, in a case when the tubular object P3 is considered as a generation source of the vibration, for example, pulsation of a liquid flowing inside the tubular object P3 is conceivable.

Also, in a case when the attached member 20 is considered as the generation source of the vibration, for example, an engine vibration of the automobile, or a vibration at a time of driving is conceivable.

(2) Second Route L2

A second route L2 is a route passing through the clamp portion 60, the locking pieces 53 of the attaching portion 50, the stud bolt 21, and the attached member 20. In the second route L2, the transmission of the vibration can be prevented due to the elasticity of the vibration-proof portions 42 of the elastic member 40.

### Second Embodiment

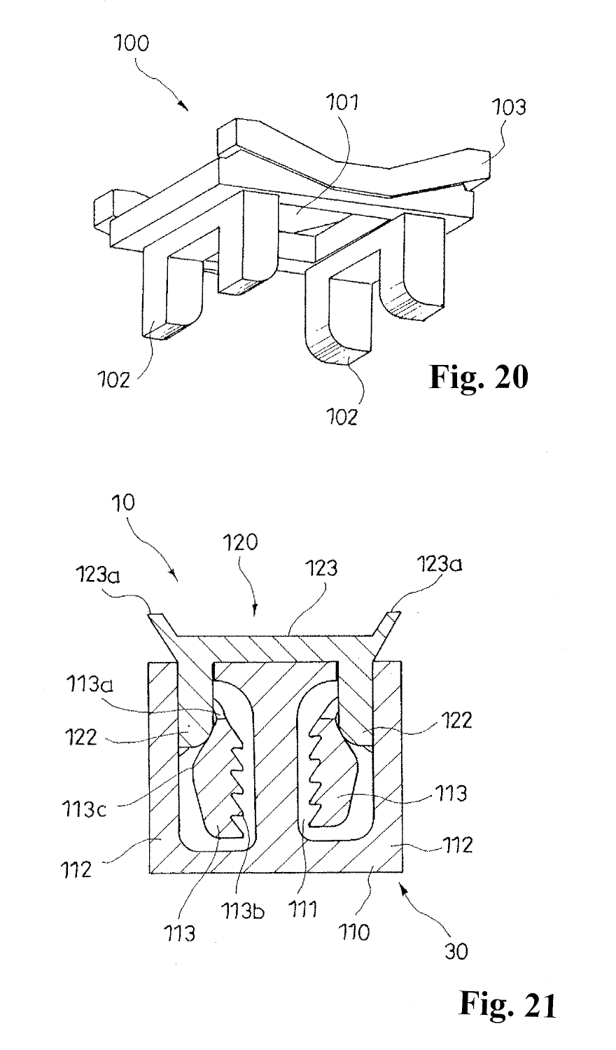

Next, a second embodiment of the present invention will be explained using FIG. 20.

A characteristic of the present embodiment is that the number of vibration-proof portions 102 of an elastic member 100 is increased.

The vibration-proof portions 102 are respectively positioned on both sides of the right and left of a communication hole 101 in FIG. 20, and are formed in an approximately downward “C” shape, or the “C” shape. The vibration-proof portions 102 are formed in a leg-like manner with a total of four pieces.

Abutting portions 103 face perpendicular to the vibration-proof portions 102, i.e., are respectively positioned on both sides of the front and back of the communication hole 101 in FIG. 20.

Incidentally, the number of the vibration-proof portions 102 is not limited to the four pieces, and may be provided with five or more pieces.

### Third Embodiment

Next, a third embodiment of the present invention will be explained using FIG. 21.

A characteristic of the present embodiment is that the elastic pieces 54 on a clip main body 30 side of the first embodiment in FIG. 3 explained earlier, are omitted, and that as shown in FIG. 21, angular elastic pieces 123a are formed in an elastic member 120.

Incidentally, as is the case with the first embodiment explained earlier using FIGS. 1 to 19, an attaching portion 110 comprises an insert hole 111, side walls 112, and locking pieces 113. The locking pieces 113 comprise hinge portions 113a, claw portions 113b, and inclined portions 113c. Also, the elastic member 120 comprises a communication hole 121, vibration-proof portions 122, and an abutting portion 123 in addition to the elastic pieces 123a.

Although it is not shown in the figures, the elastic pieces 123a elastically abut against the attached member so as to allow the over-stroke.

### Fourth Embodiment

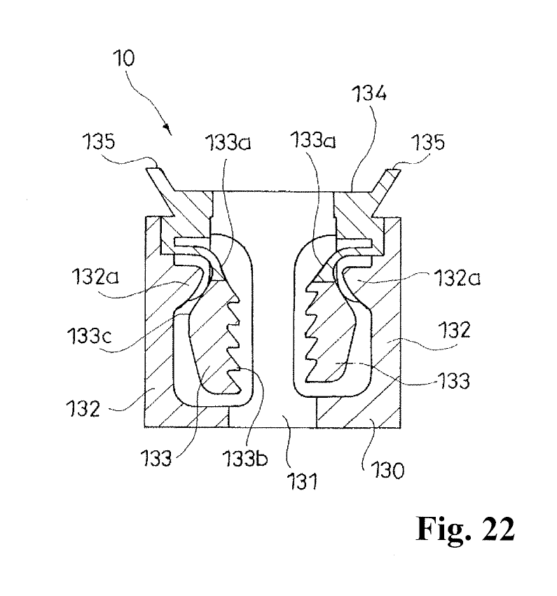

Next, a fourth embodiment of the present invention will be explained using FIG. 22.

A characteristic of the present embodiment is that the clip 10 is molded by a two-material formation using the hard resin and the soft resin.

Specifically, as is the case with the first embodiment explained earlier using FIGS. 1 to 19, the clip 10 comprises the following structure as shown in FIG. 22.

(1) Attaching Portion 130

As shown in FIG. 22, an attaching portion 130 includes locking pieces 133 which are locked in the stud bolt (not shown in the figure) provided in the attached member (not shown in the figure).

(2) Clamp Portion (not Shown in the Figure)

Although it is not shown in the figure, the clamp portion connects to the attaching portion 130, and includes the holding portion holding the tubular object.

As shown in FIG. 22, the attaching portion 130 comprises the following structure.

(3) Insert Hole 131

As shown in FIG. 22, the insert hole 131 is for inserting the stud bolt (not shown in the figure).

(4) A Pair of Side Walls 132

As shown in FIG. 22, a pair of side walls 132 faces each other by sandwiching the insert hole 131.

(5) A Pair of Locking Pieces 133

As shown in FIG. 22, a pair of the locking pieces 133 connects to the side walls 132 through thin-walled hinge portions 133a, and protrudes to the inside of the insert hole 131 so as to be locked in the stud bolt (not shown in the figure).

Incidentally, the locking pieces 133 comprise claw portions 133b and inclined portions 133c in addition to the hinge portions 133a.

(6) Upper Wall 134, Elastic Pieces 135 (Abutting Portions)

As shown in FIG. 22, an upper wall 134 is positioned on the upper surface of the attaching portion 130, and elastically abuts against the attached member (not shown in the figure).

As is the case with the angular elastic pieces 123a of the third embodiment explained earlier using FIG. 21, the elastic pieces 135 protrude in a square shape from the upper surface of the upper wall 134, and elastically abut against the attached member (not shown in the figure) so as to allow the over-stroke.

The upper wall 134 and the elastic pieces 135 function as the abutting portions. The abutting portions elastically abut against the attached member (not shown in the figure).

Incidentally, although the abutting portions are structured by both the upper wall 134 and the elastic pieces 135, the abutting portions are not limited to the above, and may be structured by either one of the upper wall 134 and the elastic pieces 135.

In the attaching portion 130, the aforementioned hinge portions 133a, the upper wall 134, and the elastic pieces 135 are molded by the soft synthetic resin.

The rest of the attaching portion 130 is molded by relatively hard synthetic resin. Incidentally, in FIG. 22, the reference numeral 132a represents projecting portions.

All contents of the specification, claims, drawing, and abstract of Japanese Patent Application No. 2009-168493 filed on Jul. 17, 2009 are cited in their entireties herein and are incorporated as a disclosure of the specification of the present invention.

What is claimed is:

1. A clip, comprising:
an attaching portion including locking pieces adapted to be locked in a stud bolt provided in an attached member; and
a clamp portion connecting to the attaching portion, and including a holding portion for holding a tubular object,
wherein the attached portion is attached with an elastic member, which is formed as a separate body from the attaching portion so as to prevent transmission of vibration between the attached member and the tubular object, and
the elastic member is provided with vibration-proof portions elastically abutting against the locking pieces.

2. A clip according to claim 1, wherein the elastic member is provided with abutting portions elastically abutting against the attached member.

3. A clip according to claim 1, wherein hollow portions are formed inside the vibration-proof portions.

4. A clip, comprising:
an attaching portion including locking pieces adapted to be locked in a stud bolt provided in an attached member; and
a clamp portion connecting to the attaching portion, and including a holding portion for holding a tubular object,
wherein the attaching portion includes:
an insert hole for inserting the stud bolt;
a pair of side walls facing each other while sandwiching the insert hole; and
a pair of locking pieces connecting to the side walls through thin-walled hinge portions, and protruding to an inside of the insert hole so as to be locked in the stud bolt, and
the hinge portion is molded by soft synthetic resin, and a rest of the attaching portion is molded by relatively hard synthetic resin.

5. A clip according to claim 4, wherein the attaching portion comprises the abutting portions elastically abutting against the attached member, and the abutting portions are molded by the soft synthetic resin.
